(19) United States
(12) Patent Application Publication
(10) Pub. No.: US 2009/0301308 A1
(43) Pub. Date: Dec. 10, 2009

(54) Filter Arrangement for Fuel Cell

(75) Inventors: Klaus Leister, Weinheim (DE); Verena Huecker, Weinheim (DE); Dieter Hintenlang, Absteinach (DE)

Correspondence Address: Davidson, Davidson & Kappel, LLC, 485 7th Avenue, 14th Floor, New York, NY, 10018, US

(73) Assignee: Carl Freudenberg, Weinheim (DE)

(21) Appl. No.: 11/922,637

(22) PCT Filed: Jun. 22, 2006
(86) PCT No.: PCT/EP2006/005998

§ 371 Date: Jul. 20, 2009

Related U.S. Application Data
(60) Provisional application No. 60/726,777, filed on Oct. 14, 2005.

(30) Foreign Application Priority Data
Jul. 1, 2005 (DE) 10 2005 031 182.2

(51) Int. Cl. H01M 8/04; B01D 46/02

(52) U.S. Cl. 96/142; 55/486

(57) ABSTRACT

A filter arrangement for cleaning fuel cell supply air, including at least two filter layers, whereby a first filter layer is designed as a coarse filter and a second filter layer as a fine filter, wherein the second filter layer includes an electret filter material.

### TECHNICAL FIELD

The invention relates to a filter arrangement for cleaning fuel cell supply air, comprising at least two filter layers, a first filter layer being designed as a coarse filter and a second filter layer as a fine filter. Furthermore, the invention comprises an arrangement for the conveying of fuel cell gases.

### PRIOR ART

Such filter arrangements are known from DE 102 30 283 A1. The filter arrangement shown there is suitable for removing particles, on the one hand, and other constituents such as noxious gases and aerosols, on the other hand, from the supply air. The particles are separated out in the first filter layer, whilst the second filter layer is equipped for removing aerosols. For this purpose, it is proposed to design the second filter layer as an electrostatic filter with ionisation. Electromagnetic filter methods are especially suitable for filtering salt-containing aerosols. With an electrostatic filter, there is the drawback that auxiliary energy is required to build up an electromagnetic field for the operation.

### DESCRIPTION OF THE INVENTION

The problem underlying the invention is to make available a filter arrangement which is suitable, without additional auxiliary energy, for the filtering of aerosols, in particular salt-containing will aerosols, and which can easily be replaced.

This problem is solved with the features of claims 1 and 7. The sub-claims relate to advantageous developments.

In order to solve the problem, the second filter layer comprises an electret filter material. Various polymer fibres are mixed together and rigidified by needles in order to produce electret filter material. As a result of intense friction, the fibres, which exhibit different electro-negativities, are charged electrostatically to a varying extent and thus become electrostatically filter-effective. The second filter layer is thus formed by a mixture of positively and negatively charged individual fibres. The polymer fibres can also be rigidified thermally or by a water jet process. The electrostatic charging can then take place by means of a plasma treatment. Filter material that comprises electrostatically charged fibres is generally referred to as electret filter material. It is particularly advantageous that fine particles can be filtered with electret filter material with a low pressure loss. On account of the electrostatic interaction, the pores can be designed, with identical filtering efficiency, larger than in the case of a non-charged filter material. Electret filter material is electrostatically filter-effective without the supply of auxiliary energy.

Such filter media can be arranged by simple means in the supply air stream and can easily be replaced. Electret filter material exhibits a good useful life and is low-cost. In the case of the filter arrangement according to the invention, the first filter layer designed as a coarse filter is arranged upstream of the second filter layer designed as a fine filter. As a result, coarser particles are first separated out in the first filter layer. The separation of fine particles by means of the electrostatic equipping takes place in the second filter layer, especially the separation of salt-containing aerosols. Aerosols are understood in this connection to mean solid or liquid particles which are present in a gas phase. The filter arrangement is particularly compact.

The first filter layer and/or the second filter layer can be made from a nonwoven fabric. Nonwoven fabrics are low-cost and easy to produce and can be adapted to various requirements by the selection of material, fibre diameters and weights per unit area. The nonwoven fabric is preferably made from a plastic, for example polyester, a polyolefin and/or polyacryl nitrile. Nonwoven fabrics can be endowed with different properties by means of different production methods, for example suitability for the filtration of particles of different size and the filtration of certain chemical constituents. The nonwoven fabric can be equipped for example with ion exchangers, in order to be able to filter, depending on the nature, basic or acid gases, for example NH₃ or SO₂.

The filter layers can be joined together in a firmly bonded manner. The filter layers are thus rigidly joined together, whereby the joined filter layers can be particularly easily assembled and replaced. In other embodiments, the filter layers can also be joined together in a keyed and/or friction-locked manner. As a result of the joining of the two filter layers, the inherent stiffness of the filter arrangement is also increased. An additional support mesh is not necessary, since on the one hand the inherent stiffness is increased by the joining and on the other hand the pressure loss of the filter arrangement is low due to the use of an electret filter material. In order to increase the inherent stiffness further, the filter layers can be embedded in a frame made from a plastic injection moulding.

The filter layers can be welded together. They can be joined together at low cost and without additional auxiliary materials, for example by ultrasound welding.

The filter layers can be designed as stampings. Stampings can be produced in a straightforward manner and in a wide diversity of shapes.

The filter layers can be joined together in a firmly bonded manner along the edges. The firmly bonded joining, in particular welding, of the edges can take place in one step with the stamping. The largest possible filter area is thereby achieved.

A further solution to the problem is an arrangement for the conveying of fuel cell gases, which comprises at least a first filter arrangement, whereby a gas conveying device and at least one further filter arrangement are assigned to the first filter arrangement. Particles and liquid aerosols are retained in the filter arrangement according to the invention upstream of the gas conveying device. Further constituents are retained by the further filter arrangement. These can be noxious gases from the surroundings, but also liquid, gaseous or particulate constituents of the gas conveying device. Typical emissions of a gas conveying device are for example lubricating or hydraulic oils as well as softening agents, parting agents and particulate constituents caused by wear. These are retained by the further filter arrangement and protect the downstream fuel cell against damage due to these constituents.

The further filter arrangement can comprise a chemical filter. By means of the chemical filter, noxious gases that can cause damage to the downstream fuel cell can be removed from the supply air or the gas conveying device.

The further filter arrangement can comprise an activated carbon layer. Depending on the equipment, the activated carbon forms an adsorption filter and/or an absorption filter. An activated carbon is suitable for the filtration of various chemicals constituents as well as particles. Other sorbent agents can also be provided in the further filter arrangement. The latter can act through physisorption or chemisorption. Impregnated carbons, silicon dioxides, aluminium silicates, aluminium oxides or ion exchangers, for example, are conceivable. The further filter arrangement can additionally comprise upstream and/or downstream particle filters. Against this background, it is also conceivable for the activated carbon layer to comprise activated carbon fibres and/or activated carbon granulate.

The use of the filter arrangement or the arrangement in a fuel cell is advantageous in a mobile device. The use in a mobile device and here, in particular, a maritime device or one close to the sea, is particularly advantageous, since the filter arrangement on the one hand does not require any auxiliary energy and on the other hand is particularly compact. The filter arrangement and the arrangement can be providing flexibly in compact fuel cell units.

Furthermore, the filter arrangement according to the invention is equipped for the filtration of the salt-containing and particle-loaded supply air. The filter arrangement can be designed compact and easily replaceable. Against this background, an application in stationary installations is also conceivable. Fixed property, for example, is subject, depending on the location, to a heavy aerosol pollution. The described filter arrangements and arrangements can be effectively used to counter this.

### BRIEF DESCRIPTION OF THE DRAWING

Several examples of embodiment are explained below in greater detail with the aid of the figures. In the figures,

FIG. 1 shows diagrammatically a filter arrangement and

FIG. 2 shows diagrammatically an arrangement in a mobile device.

### EMBODIMENT OF THE INVENTION

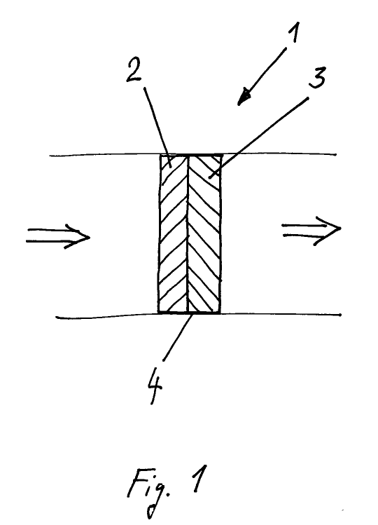

FIG. 1 shows a filter arrangement 1 for cleaning fuel cell supply air. Filter arrangement 1 is arranged in supply air stream 9 of a fuel cell 8. Filter arrangement 1 comprises two filter layers 2, 3 made from nonwoven fabric. First filter layer 2 is made from a polyolefin nonwoven fabric and is designed as a coarse filter for the filtration of coarse particles. Second filter layer 3 is made from an electret filter material and is designed as a fine filter for the filtration of finer particles, in particular salt-containing aerosols. The electret filter material is formed by a mixture of polypropylene and polyacryl nitrile fibres and has a supporting nonwoven fabric of polyester. The two filter layers 2, 3 are designed flat. In other embodiments, filter layers 2, 3, in particular first filter layer 2, can also be designed as folded filters. The formation of the two filter layers 2, 3 takes place by stamping, whereby in this embodiment edges 4 of filter layers 2, 3 are welded during the stamping and are thus joined in a firmly bonded manner. Filter layers 2, 3 can also be joined by ultrasound welding. The thickness of the assembled filter arrangement 1 amounts in this embodiment to less than 15 mm and is thus particularly compact.

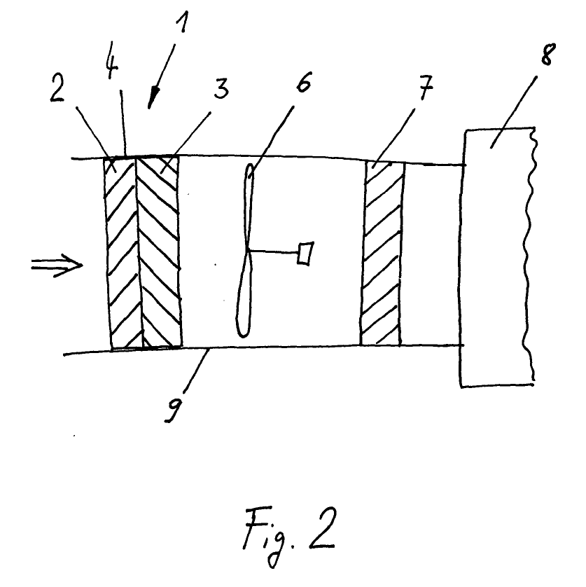

FIG. 2 shows an arrangement 5 for conveying fuel cell gases. The arrangement comprises a filter arrangement 1, a gas conveying device 6 downstream of filter arrangement 1 and a further filter arrangement 7 downstream of gas conveying device 6. Filter arrangement 1 comprises in each case two filter layers 2, 3 made from nonwoven fabric. First filter layer 2 is made from a polyolefin nonwoven fabric and is designed as a coarse filter for the filtration of coarser particles. Second filter 3 is made from an electret filter material and is designed as a fine filter for the filtration of finer particles, in particular salt-containing aerosols. Gas conveying device 6 is constituted as a membrane pump in this embodiment. Further filter arrangement 7 comprises a chemical filter which is formed by an activated carbon layer. Emissions from gas conveying device 6 as well as further noxious gases are retained by further filter arrangement 7. Furthermore, emissions of other constituents, e.g. softening agents from plastics, which can lead to premature wear of fuel cell 8, can also be filtered. Arrangement 5 is arranged in a supply air line 9 of a fuel cell 8. Fuel cell 8 is assembled in a mobile device, in this embodiment is a watercraft, for example a sailing ship.

1-10. (canceled)

11: A filter arrangement for cleaning fuel cell supply air, comprising at least two filter layers whereby a first filter layer is designed as a coarse filter and a second filter layer as a fine filter, wherein the second filter layer comprises an electret filter material.

12: The arrangement as recited in claim 11, wherein the first filter layer and/or the second filter layer are made from a nonwoven fabric.

13: The arrangement as recited in claim 11, wherein the filter layers are joined together in a firmly bonded manner.

14: The arrangement as recited in claim 11, wherein the filter layers are welded together.

15: The arrangement as recited in claim 11, wherein the filter layers are formed as stampings.

16: The arrangement as recited in claim 15, wherein the filter layers are joined together in a firmly bonded manner along the edges.

17: An arrangement for conveying fuel cell gases, comprising at least a first filter arrangement as recited in claim 11, whereby a gas conveying device and at least one further filter arrangement are assigned to the first filter arrangement.

18: The arrangement as recited in claim 17, wherein there is arranged. downstream of the first filter arrangement, in the gas flow direction, a gas conveying device, which is followed by at least one further filter arrangement.

19: The arrangement as recited in claim 17, wherein the further filter arrangement comprises a chemical filter.

20: The arrangement as recited in claim 19, wherein the further filter arrangement comprises an activated carbon layer.
